(19) United States
(12) Patent Application Publication
(10) Pub. No.: US 2026/0197402 A1
(43) Pub. Date: Jul. 9, 2026

(54) SYSTEM AND METHOD FOR REDISTRIBUTING RESOURCES

(71) Applicant: Verizon Patent and Licensing Inc., Basking Ridge, NJ (US)

(72) Inventor: Rajkumar Bondugula, Coppell, TX (US)

(21) Appl. No.: 19/010,685

(22) Filed: Jan. 6, 2025

(51) Int. Cl. H04M 3/523; H04M 3/51

(52) U.S. Cl. CPC H04M 3/5233; H04M 3/5175

(57) ABSTRACT

A device may include a processor. The processor may be configured to: receive a request to re-rank a list of ranked agents or callers; when there are more agents than callers, generate a list of re-ranked agents based on the list of ranked agents; and provide the list of re-ranked agents to a component in a system for routing calls to one of agents identified in the list of re-ranked agents.

### BACKGROUND INFORMATION

Call centers use a variety of technologies to enhance customer service, agent productivity, and operational efficiency. Communication infrastructure includes Voice over IP (VoIP) and the Public Switched Telephone Network (PSTN), with Automatic Call Distributors (ACDs) managing call routing. Interactive Voice Response (IVR) automates caller interactions, while Computer Telephony Integration (CTI) connects agents to customer databases. Programs like chatbots, speech analytics, and predictive dialers automate tasks and optimize agent pairing. Agent Management Systems (AMS) track agent availability, and Call Monitoring and Analytics Tools provide performance insights through real-time dashboards. Cloud-based platforms such as Contact Center as a Service (CCaaS) are reshaping the industry with scalable, AI-integrated solutions.

### BRIEF DESCRIPTION OF THE DRAWINGS

FIG. 1 illustrates an example environment in which systems and methods described herein may be implemented.

FIG. 2A illustrates exemplary logical components of a resource processor management system, according to an implementation.

FIG. 2B illustrates exemplary components of a resource processor management system, according to an implementation.

FIG. 3 illustrate exemplary components of a resource balancer, according to an implementation.

FIG. 4 illustrates an table summarizing example input to a re-pairing model, according to a first implementation.

FIG. 5 is a flow diagram of an example process that is associated with a re-pairing model, according to the first implementation.

FIGS. 6A-6D show tables summarizing example inputs to and the corresponding outputs from a re-pairing model, according to the first implementation.

FIGS. 7A and 7B show tables summarizing example inputs to a re-pairing model, according to a second implementation.

FIG. 8 is a flow diagram of an example process that is associated with a re-pairing model, according to the second implementation.

FIG. 9 illustrates exemplary components of a resource balancer, according to the second implementation.

FIGS. 10A and 10B are flow diagrams of an example process that is associated with a re-pairing model, according to a third implementation.

FIGS. 11A and 11B are flow diagrams of an example process that is associated with a re-pairing model, according to a fourth implementation.

FIG. 12 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID) or another identifier.

Systems and methods described herein relate to a resource redistribution system. In many electrical or mechanical systems, Artificial Intelligence (AI) and another decision making mechanism may be used to rank resources for processing. These resources can include processing units (e.g., microprocessors, memory recycling units, people, call agents, etc.) with specialized capabilities, such as providing products with specific attributes. However, many AI-based ranking systems are rigid in how they learn and interpret data, making biases difficult to detect and even harder to correct. Relying solely on AI-generated rankings can cause significant issues, including both over-utilization and under-utilization of the processing units. For example, in networking, incoming data may be distributed over several routers, which operate as processing units, each with a given load, connectivity to other network components, and a bandwidth. Based on these parameters, an AI system may favor a particular router, ranking it higher than other routers, even though the other routers may be available are closer to being underutilized, and closer to breaching their operating thresholds.

In another example, in a call center, if an AI model ranks agents (e.g., AI call handlers, devices for handling calls, or human call agents) based on predicted performance, top-ranked agents may be repeatedly assigned calls, while other agents with similar skill levels are overloaded due to minor score differences. In the case of human call agents, this can result in agent burnout for frequently selected agents and under-utilization of others. Agents who scored low due to biases in the model might remain idle, even if they have the capacity to handle the incoming calls. In the case of human agents, pay may depends on the number of calls received, this can lead to problems.

Similarly, if AI ranks incoming calls based on perceived risk, certain calls may never be responded to, resulting in missing high priority calls. Some call types may also be prioritized at the expense of others, exacerbating processing imbalances. A similar bias can occur in product ranking. Products that are frequently viewed or purchased might be continually promoted due to primacy and recency effects, where consumer agents prefer items shown first or last. Once this bias starts, these products dominate search rankings, even when other products are equally competitive.

The systems and methods described herein address these issues. More specifically, resource balancers are implemented. The systems may mitigate AI bias by first binning AI scores into predefined categories (e.g., deciles or percentiles). If multiple processing units or products fall into the same bin, secondary criteria are used as tie-breakers to ensure fair distribution.

In the call center context, agent idle time or current workload can serve as tie-breakers. Additionally, the systems may dynamically adjust bin definitions based on agent availability and ongoing chats. In product management, similar secondary criteria, such as profit margins or inventory levels, can resolve ties. For example, if different color variants of a product have similar AI scores, the system can promote those with higher inventory or better profit margins. These metrics also can help redefine equivalent bins dynamically, ensuring continuous optimization of rankings and resource allocation.

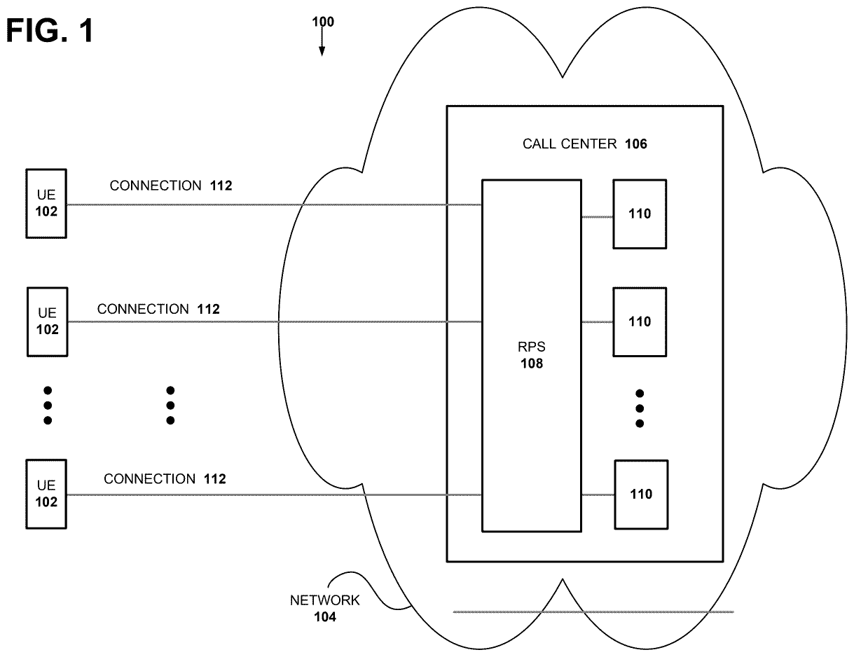

FIG. 1 illustrates an example environment 100 in which systems and methods described herein may be implemented. As shown, environment 100 may include one or more communication-capable devices (herein referred to as User Equipment devices (UEs 102) and a network 104. UEs 102 may include a wireless communication device capable of Fourth Generation (4G) (e.g., Long-Term Evolution (LTE)) communication, Fifth Generation (5G) New Radio (NR) communication, and/or other wireless or wired communication. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor; an Internet-of-Things (IoT) device; a Fixed Wireless Access (FWA) device; and a Customer Premises Equipment (CPE) device with 4G and 5G capabilities. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-Internet of Things (IoT) devices.

Network 104 may include one or more networks connected to provide various services. Network 104 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Network 104 may include an application server (not shown; also referred to as application). An application may render services to other applications running on UEs 102 and may establish communication sessions with UEs 102.

As further shown, network 104 may include a call center 106, which in turn includes a resource processor management system (RPS) 108 and one or more processing units 110 or agents 110 (e.g., an AI agent, a software agent, a human agent, etc.). When a UE 102 calls call center 106 (e.g., connection 112), RPMS 108 may direct the call to one of agents 110. As used herein, the term “call” may refer to an automated communication from an application on UE 102, a Voice-over-IP (VoIP) call, a telephone call, a video-over-IP call, a chat/text call (a text based session), or a combination of a video/voice/chat, over communication paths comprising a wireless link, a wired link, an optical link, or a combination thereof. RPMS 108 may use a variety of technologies to enhance customer service, agent productivity, and operational efficiency of call center 106.

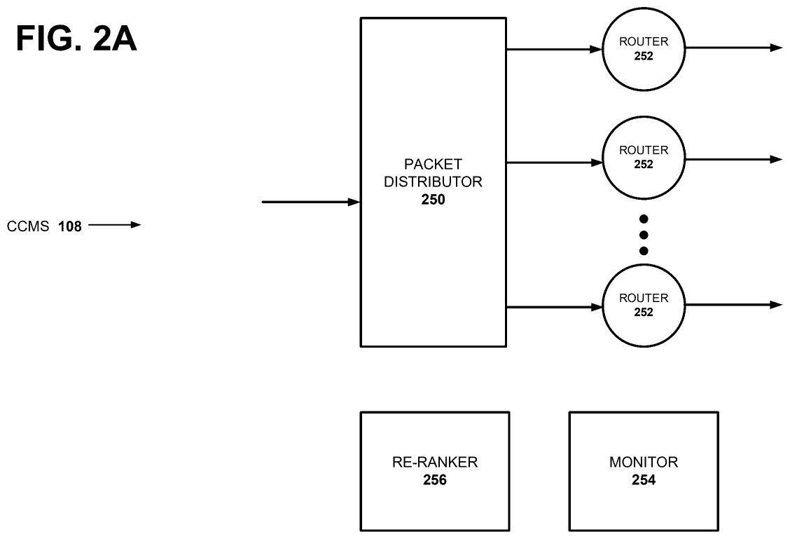

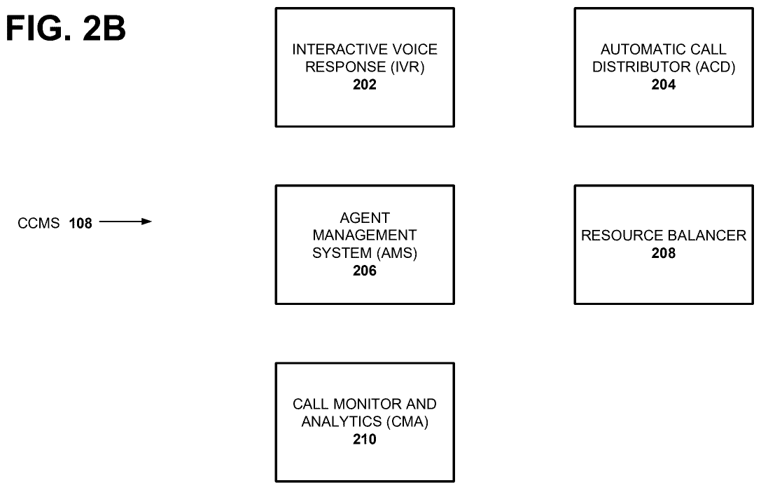

FIG. 2A illustrates exemplary logical components of RPMS 108, according to an implementation. In this implementation, RPMS 108 may include a packet distributor 250, routers 252, a monitor 254, and a re-ranker 256. Packet distributor 250 may receive packets and distribute the packets for routing among different routers 252, each of which may be capable of routing the packets received from packet distributor 250 to the intended destinations. Packet distributor 250 may determine which router 252 to handle a particular packet based on a router rankings (e.g., for a particular address) output by the re-ranker 254.

Router 252 may route packets received from packet distributor 250 toward their intended destinations. Each router 252 may or may not have the same configurations, such as network connectivity, bandwidth, processing speed, buffer availability, latency, etc. Monitor 254 may measure operating parameters that are associated with each of routers 252 and provide the monitored parameters to re-ranker 256. For example, monitor 252 may obtain average latencies, available buffer size, bandwidth, latency, etc., that are associated with each of routers 252 (e.g., for a particular destination) and provide the measured parameter values to re-ranker 256. In some implementations, monitor 254 may provide a parameter that measures a time-to-breach (e.g., how close router 252 is to being too underutilized).

Re-ranker 256 may determine, based on the monitored data provided by monitor 254, a ranked list of routers 252 to packet distributor 250. In one implementation, re-ranker 256 may perform an initial ranking of routers 252 based on a primary parameter, such as processing speed or latency, via an AI-based system or based on a particular distribution algorithm.

In one implementation, re-ranker 256 may re-rank routers 252 that already have been ranked via an AI system or another system. To re-rank routers 252, re-ranker 256 may categorize each of the routers 252 into bins based on a performance data and re-prioritize the routers 252 based on their times to breach. In this manner, re-ranker 256 may remove some of the biases injected into the initial rankings of routers 252 for particular destinations.

FIG. 2B illustrates exemplary components of RPMS 108, according to a different implementation. As shown, in this implementation, RPMS 108 may include an interactive voice response system (IVR) 202, an automatic call distributor (ACD) 204, an agent management system (AMS) 206, a resource balancer 208, and a call monitoring and analytics system (CMA) 210. Depending on the implementation, RPMS 108 may include additional, fewer, or different components those illustrated.

IVR 202 may interact with callers (UEs 102), gather information, and route calls to appropriate agents 110. IVR 202 may provide pre-recorded messages, process customer inputs, and handle simple tasks without human agents. Example inputs to IVR 202 include incoming calls and caller inputs (e.g., keypad entries or voice commands). Example outputs include collected caller information (e.g., reason for calling), call routing instructions (e.g., forward to a specific department or agent), and/or automatic responses (e.g., account balances).

ACD 204 may manage and may route incoming calls based on predefined rules, such as agent availability, call priority, and caller information. Example inputs include caller details from the IVR 202, agent availability data from the AMS 206, business rules (e.g., skills-based routing policies), caller information from IVR 202 and/or CMA 210, and agent information from AMS 206 (e.g., agent availability information). Example outputs include calls routed to appropriate agents or queues, queue status updates (e.g., estimated wait time), and call logs for CMA 210.

AMS 206 may track real-time agent status, including availability, idle time, ongoing tasks, and workload history. AMS 206 may ensure that agents are effectively utilized by providing up-to-date status information to other components, such as ACD 204 and resource balancer 208. Example inputs include agent login/logout data, call handling events (e.g., call start/end, hold time), and agent performance data (from the CMA 210). Example outputs include agent availability updates to the ACD 204 and/or resource balancer 208, and agent workload data to ACD 204 and/or resource balancer 208.

Resource balancer 208 may use AI-based (or another type of) rankings and real-time agent data to assign tasks to agents while ensuring fair workload distribution. Resource balancer 208 may mitigate overloading agents and may balance tasks based on system-defined policies (e.g., least busy, longest idle, maximum profit, etc.). Example inputs include agent availability and workload from the AMS 206, a caller ID or IDs, agent or caller scores from CMA 210 (e.g., call priority, expected revenue, etc.), and business rules for load balancing (e.g., idle-agent-first policy). Example outputs include call assignment decisions to ACD 204, and adjusted call distribution updates to AMS 206. In one implementation, given a caller ID or caller IDs, resource balancer 208 may provide a ranked list of agents for handling the call (i.e., agent rankings).

CMA 210 may monitor call center performance by tracking agent productivity, call metrics (e.g., average handle time, service-level agreement (SLA) breaches), and customer satisfaction scores. CMA 210 may provide reports on potential operational improvements. Example inputs include call event data from ACD 204, agent performance metrics from AMS 206, and call assignment data from resource balancer 208 and/or ACD 204. Example outputs include real-time and reports, SLA compliance summaries, historical performance data for performance, and forecasts.

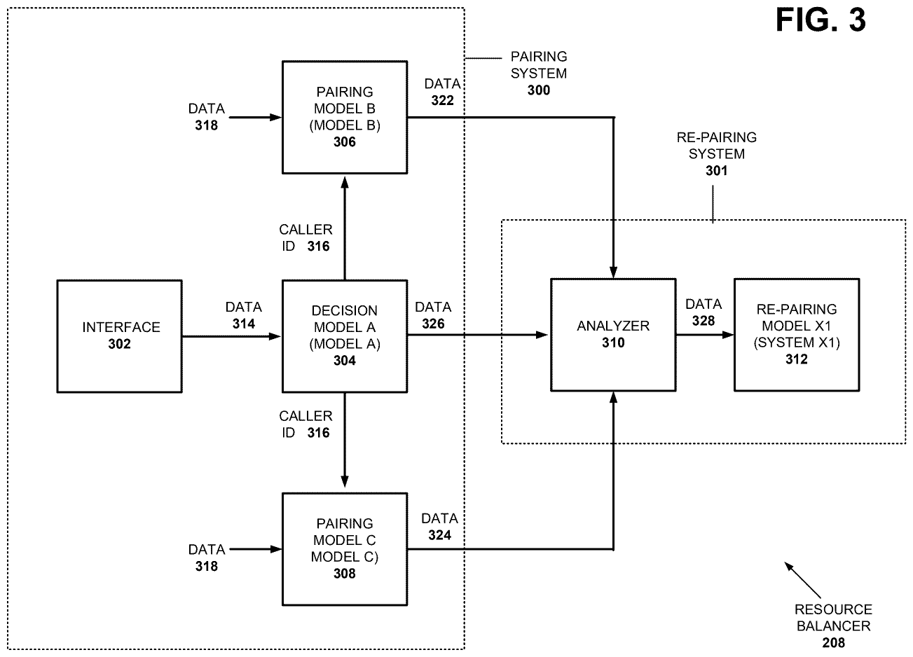

FIG. 3 illustrates exemplary components of resource balancer 208, according to a first implementation. As shown, resource balancer 208 may include a pairing system 300 and a re-pairing system 301. Pairing system 300 may generate a ranked list of agents or callers that may optimize call center performance. Re-pairing system 301 may re-rank the list of agents or caller generated by pairing system 300, to remove biases that pairing system 300 may have injected into its rankings.

As further shown, pairing system 300 may include input interface 302, a decision model A (model A) 304, a pairing model B (model B) 306, and a pairing model C (model C). Interface 302 may receive an identifier (ID) of the client whose call is to be routed, IDs of agents (in call center 106) who may receive the call (and other information, such as agent availability, agent performance, etc.) and provide the information needed by model A 304, model B 306, model C 308, and/or another component.

Model A 304 may assess a risk associated with the customer identified by the customer ID based on data 314 provided by interface 302 (e.g., probability of losing a sale or gaining a sale). Depending on the risk (represented by a configurable threshold TR), model A 304 may forward the caller ID 316 (a customer ID, a client ID, etc.) to model B 306 (e.g., risk>=TR) or may forward the caller ID 316 to model C 308 (e.g., risk<TR). Upon receipt of the caller ID 316 and data 318 from interface 302, model B 306 may generate a list of ranked agents, with a score for each of the agents. Each score, which may be in a certain range (e.g., [−$1000s to $1000s]) may represent a past or predicted performance change (e.g., a change in revenue generated at call center 106) if the current caller is paired with the agent. Similarly, when model C 308 receives caller ID 316, model C 308 may use the caller ID and data 318 from interface 302 to generate a list of ranked agents and the corresponding scores. Accordingly, for each incoming caller ID received at interface 302, pairing system 300 may output a ranked list of agents (and other data) via either model B 306 or model C 308. By changing the TR, pairing system 300 may change the total proportion of the incoming calls and the total portion of revenue changes due to model B 306 and model C 308.

Re-pairing system 301 may include a first implementation and a second implementation. In both the first and second implementations, re-pairing system 301 may include an analyzer 310 and a re-pairing model X1 312. In the first implementation, analyzer 310 and re-pairing model X1 312 may be configured to re-rank agents when call center 106 is in agent surplus (AS)—that is, when more agents are available than callers at any given time. In the second implementation, analyzer 310 and re-pairing model X1 312 may be configured to re-rank callers and/or agents when call center 106 is in caller surplus (CS)—that is, when there are more callers than available agents.

In the first implementation, analyzer 310 may be configured to receive the ranked list of agents and scores from either model B 306 or model C 308, along with other data (e.g., data 322 or data 324, and/or data 326 passed from interface 302 via model A 304). Analyzer 310 may use the received ranked list and other data to generate and provide input data 328 to re-pairing model X1 312.

According to the first implementation, data 328 may include: caller ID or IDs of the callers; agent IDs; indication of which of model B 306 and model C 308 provided the rankings from pairing system 300; for each of the agent IDs, a score in a range (e.g., an amount of additional revenue that may be generated or lost). Data 328 may further include: for each of the agents or the callers, a decile to which the agent belongs; equivalent decile spreads for model B 306 (BEDS); equivalent decile spreads for model C 308 (CEDS); a time to SLA breach (TTSLAB); and Top N deciles for agents nearing breach (TNDANSB).

The terms “bin” and “decile” may be broadly interpreted as a bin spanning 1/N of the entire range of score, where N is an integer (e.g., N=8, 10, 14, 20, or another whole number). For example, if a score is in the range [−1000, 1000], a decile may occupy the range [−1000, −950], Each of the deciles may be designated by a whole number in the range [1, 10]. Thus, for example, decile number 10 (or 10th decile or decile 10) may refer to the decile of the range [800,1000], decile number 9 may refer to decile [600, 800], etc. As used herein, an agent may belong to a decile N if the score associated with the agent is in Nth decile.

BEDS may refer to, for model B 306, the number of consecutive deciles or bins minus one that maybe considered equivalent (e.g., the contribution of agent score in one decile/bin to the performance metric is considered equivalent to the contribution of agent scores in another decile/bin). For example, if decile 10 and 9 are equivalent, then the BEDS is 1. In another example, if deciles 8, 9, and 7 are equivalent, then the BEDS is 2. The number of equivalent deciles, the higher the chances of more agents being considered for pairing. The number of deciles is counted from the highest decile of the highest ranked agent. For example, if the highest ranked agent belongs to decile 7 and if BEDS is set to 1, agents belonging to deciles 7 and 6 are considered equivalent based on a criterion (e.g., revenue). If the highest ranked agent belongs to decile 9 and if BEDS is set to 2, agents belonging to deciles 9, 8 and 7 are considered equivalent. Analyzer 310 setting BEDS high may compromise call center 106 goal. If model B 306 is used to rank high risk calls, to maintain the optimization, BEDS may be set lower than the CEDS. In one implementation, analyzer 310 may set the default value of BEDS to 1.

CEDS may refer to, for model C 308, the number of consecutive deciles minus one that maybe considered equivalent, in the manner similar to that for the BEDS. Analyzer 310 setting the CEDS high may compromise the call center 106's goals. In one implementation, analyzer 310 may set the default value of CEDS to 2.

TTSLAB may be in a specific range (e.g., [0, 60]) and may represent a threshold (e.g., a threshold time for which an agent has been idle). TTSLAB may be used to determine which agents should be paired preferentially so that SLA breach conditions might be avoided as much as possible. Agents may belong to this preferential group if they are less than TTSLAB seconds away from triggering the SLA breach. Typically, the bigger the TTSLAB, the higher the chances that agents 110 have been paired using an AI pairing model. In one implementation, analyzer 310 may set the default value of TTSLAB to 45 seconds, for example.

TNDANSB may refer to top N deciles in which the agents are close to breaching the SLA. In one implementation, TNDANSB may be expressed as a list of numbers enclosed by a pair of brackets. For example, if deciles 8-10 are the top N deciles, then TNDANSB=[8, 9, 10]. TNDANSB may be set starting with the largest decile (e.g., decile 10). Larger TNDANSB may indicate a greater leeway for taking chances with potential breaches. For example, the TNDANSB=[4,5,6,7,8,9,10] may be considered larger than TNDANSB of [7, 8, 9]. Any agent near breaching SLA threshold and belonging to TNDANSB deciles, the higher the chance that the agent is paired using the AI pairing. Analyzer 310 setting TNDANSB to a wide range may compromise the optimization goals of model B 306 or model C 308. In one implementation, analyzer 310 may set the default value of TNDANSB=[6,7,8,9,10].

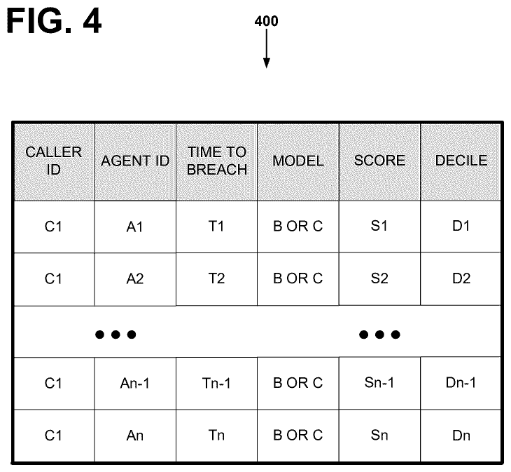

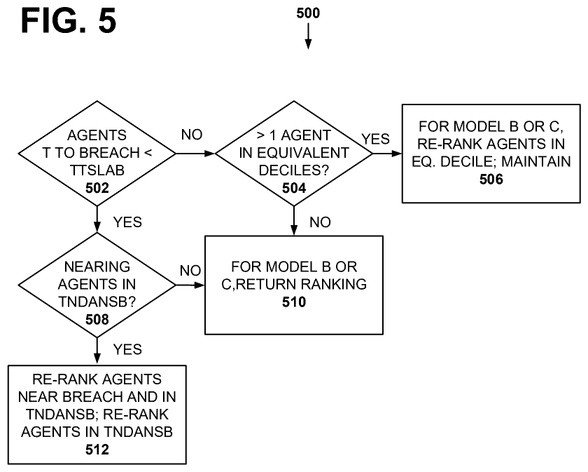

Data 328 may further include a request, with specific arguments, parameters, and other data, to re-pairing model X1 312. In response, re-pairing model X1 312 may re-rank the agents, for pairing with a particular caller. FIG. 4 shows a table summarizing example inputs to re-pairing model X1 312. An example process that re-pairing model X1 312 may perform for re-ranking agents is discussed below with reference to FIG. 5.

FIG. 4 illustrates a table summarizing example input to re-pairing model X1 312, according to the first implementation—for re-pairing agents when there are more agents available to handle calls than callers. To make a request to re-pairing model X1 312, after preparing data as discussed above with reference to FIG. 3, analyzer 310 may provide the following information as arguments to re-pairing model 312: an indication from pairing system 300 whether the ranking is generated by model B 306 or model C 308; raw scores of the ranked agents and score deciles of the agents and agent time-to-breach the SLA. In addition, analyzer 310 may set values for TTSLAB, TNDANSB, BEDS, and CEDS (e.g., TTSLAB=45 seconds, TNDANSB=[5, 6, 7, 8, 9, 10], BEDS=0, and CEDS=2). In addition, analyzer 310 may provide the information shown in table 400 in the re-ranking request to re-pairing model X1 312.

As shown, given a particular caller and each of the agents in the ranked list (from pairing system 300), the request may include: a caller ID; an agent ID; a time-to-breach for each agent; an indication whether the ranking is from model B 306 or model C 308; a score provided by the model; and a score decile. When re-pairing model X1 receives the input, re-pairing model X1 312 may perform a particular process to generate a re-ranked list of agents.

FIG. 5 is a flow diagram of an example process 500 that is associated with re-pairing model X1 312, according to the first implementation. As shown, process 500 may include determining if there are any agents with time-to-breach<TTSLAB and identifying those agents (block 502). If there are such agents (block 502: YES), re-pairing model X1 312 may determine if there are agents, which are close to breach, who are also in TNDANSB (block 508). If agents whose time-to-breach is close to SLA breach but are not in TNDANSB, re-pairing model X1 312 may return, for those agents close to breaching the SLA, the same rankings as those provided by model B 306 or model C 308 (block 510).

On the other hand, if the agents with time-to-breach close to breach are in TNDANSB (block 508: YES), re-pairing model X1 312 may proceed to: re-rank agents that are close to breach and are also in TNDANSB in the order of increasing time-to-breach; re-rank agents TNDANSB in the order of increasing time-to-breach; and for the remainder of the agents, maintain the rankings provided by model B 306 or model C 308 (block 512).

At block 502, if there are no agents whose time-to-breach is<TTSLAB (block 502: NO), re-pairing model X1 312 may determine whether there are more than one agent in the equivalent deciles (e.g., BED or CED) (block 504). If there are no such agents (block 504: NO), re-pairing model X1 312 may return the rankings obtained from model B 306 or model C 308 (block 510). Otherwise (block 504: YES), re-pairing model X1 312 may re-rank agents in the equivalent deciles (in either BED or CED) in the order of increasing time-to-breach (block 506). For the remainder of the agents, re-pairing model X1 312 may maintain the rankings from model B 306 or model C 308.

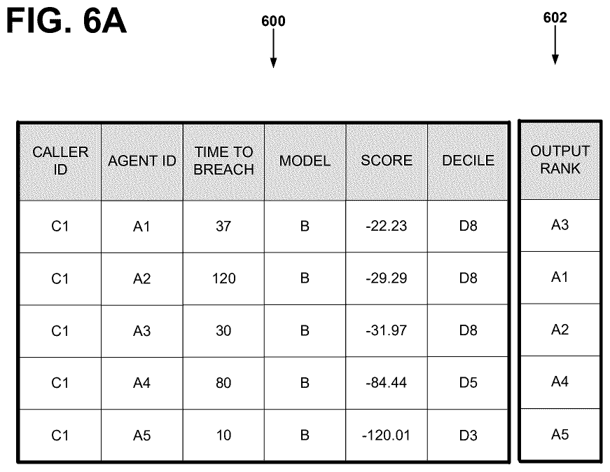

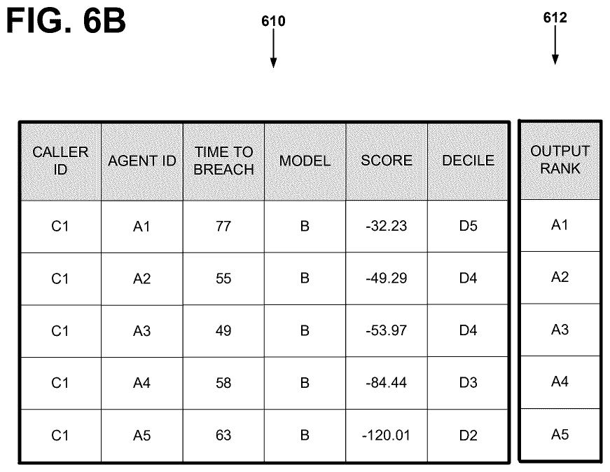

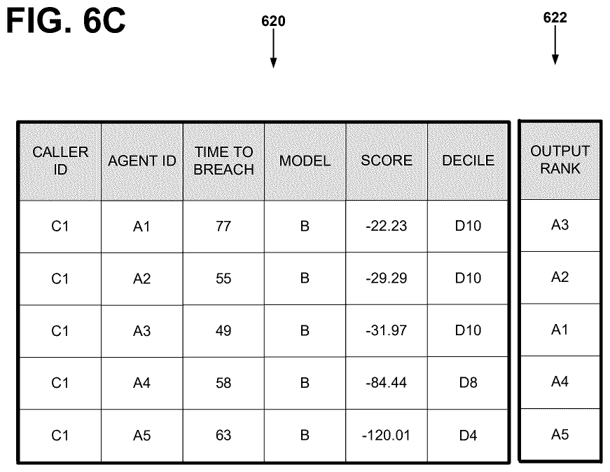

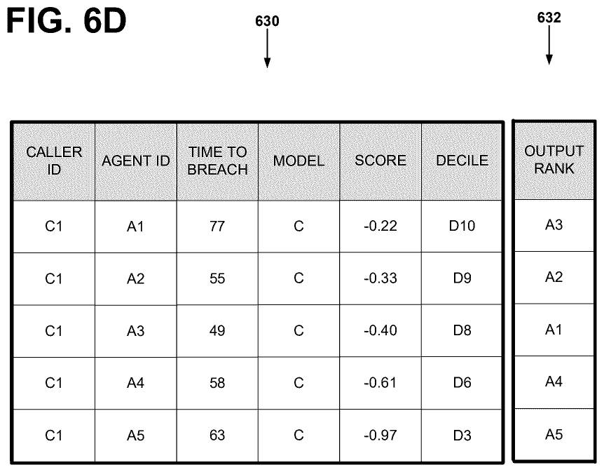

FIGS. 6A-6D show tables summarizing example inputs to and the corresponding outputs from re-pairing model X1 312, according to the first implementation. Referring to FIG. 6A, table 600 shows that time-to-breach for agents A1, A3, A5<45; and A1 and A3 belong to TNDANSB. Accordingly, re-pairing model X1 312 may arrange A3 and A1 in the ascending order of time-to-breach; prioritize A2; and maintain the rankings for A4 and A5 from model B 306. The resulting ranking of A3, A1, A2, A4, and A4 is shown in table 602.

In FIG. 6B, table 610 shows that no agent is nearing the breach, and only one agent belongs to the top decile spread group D5. Accordingly, re-pairing model X1 312 outputs the ranking A1, A2, A3, A4, and A5, without any changes to the rankings from model B 306, as shown in table 612.

In FIG. 6C, table 620 shows that no agent is near TTSLAB, which is 45 seconds in this example; and that agents A1, A2 and A3 belong to the top decile spread group D10. Accordingly, re-pairing model X 312 may change the rankings for agents A1, A2 and A3 in the order of ascending time-to-breach; and maintain the rankings for agent A4 and A5. Therefore, re-pairing model X1 312 outputs the ranking of agents A3, A2, A1, A4, and A5, as shown in table 622.

In FIG. 6D, table 630 shows that no agent exceeds TTSLAB; agents A1, A2, and A3 belong to the equivalent decile group since model C generated the scores and the CEDS=2. Accordingly, re-pairing model X1 312 may sort agents A1, A2, and A3 in the order of ascending time-to-breach: A3, A2, and A1; and maintain the rankings for A4 and A5, as shown in output table 632.

As described above, in the first implementation, analyzer 310 and re-pairing model X1 312 may be configured to re-pair agents with callers when there are more agents available than the callers at a given time. In the second implementation, analyzer 310 and re-pairing model X1 312 may be extended or modified to re-pair agents to callers when call center 106 is in caller surplus (e.g., there are more callers than agents at a given time) as well as when call center 106 is in agent surplus (e.g., there are more agents available than callers at a given time).

In the second implementation, analyzer 310 may be configured to receive the ranked list of agents and scores from either model B 306 or model C 308, along with other data (e.g., data 322 or data 324, and/or data 326 passed from interface 302 via model A 304). Analyzer 310 may use the received ranked list and other data to generate and provide input data 328 to re-pairing model X1 312. In contrast to the first implementation, in the second implementation, analyzer 310 may also receive, from pairing system 300, whether call center 106 is in agent surplus (AS) or a caller surplus (CS).

In the second implementation, data 328 may include: caller IDs; agent IDs; an indication of which of model B 306 and model C 308 generated the rankings from pairing system 300; an indication of whether the request for re-pairing is for AS or CS ; for each of the agent ID, a score in a range (e.g., an amount of additional revenue generated or lost); for each of the agents during agent surplus, a decile to which the agent score belongs; BEDS (or AS_BEDS); CEDS (or AS_CEDS); a time to SLA breach during AS (TTSLAB or AS_TTSLAB); and Top N deciles for agents nearing breach (TNDANSB or AS_TNDANSB). These data types/parameters have been described above with respect to the first implementation.

In addition, data 328 may also include: CS Time to SLA Breach (CS_TTSLAB); CS First Priority Pairing Deciles for model B (CS_FPDB); CS First Priority Pairing Deciles for model C (CS_FPDC); CS Second Priority Pairing Deciles for Model B (CS_SPDB); and CS Second Priority Pairing Deciles for Model C (CS_SPDC).

CS_TTSLAB may indicate which caller should be paired preferentially so that SLA breach conditions might be avoided as much as possible based on the conditions at call center 106 (e.g., number of callers, agents, etc.). Callers belong to this preferential group if they are less than TTSLAB seconds away from triggering an SLA breach. The bigger this number, the higher the chances that agents were paired using the AI pairing. In one implementation, CS_TTSLAB may be in the range [0, 60] with the default value of 45 seconds.

CS_FPDB may designate, in absolute terms, particular deciles to be given the priority in pairing when model B 306 in pairing system 300 generated the ranking. The higher the number of deciles starting from 10, the higher the chances of more customers being considered for pairing. Setting this number high may compromise the optimization goal (e.g., maximizing revenue). If model B 306 was used to rank high risk calls in ranking system 300, more conservative values (e.g., a CS_FPDB of [10] or [9,10]) may allow re-pairing model 312 to avoid comprising the optimization goals. In one implementation, CS_FPDB may include deciles in the range of [1, 10] and the default value=[9, 10].

CS_FPDC may designate, in absolute terms, particular deciles to be given the priority in pairing when model C 308 generated the ranking. The higher the number of deciles starting from 10, the higher the chances of more callers being considered for pairing. Setting this number high may compromise the optimization goals of the models. If model C 308 was used to rank lower risk calls in ranking system 300, a wider range of values (e.g., CS_FPDC of [8, 9, 10]) may still be used without comprising the optimization goals. In one implementation, CS_FPDC may include deciles in the range of [1, 10] and the default value=[8, 9, 10].

CS_SPDB may designate, in absolute terms, particular deciles for callers nearing breach for pairing when model B 306 generated the ranking. CS_SPDB may specify a broader range of deciles (towards the lower side of the score) than CS_FPDB. The higher the number of deciles starting from 10, the higher the chances of more callers being considered for pairing. In addition, the larger the range, the higher the chances that agents may be paired using the AI pairing. Setting this range very broadly (e.g., a large range) may compromise the optimization goals. If model B 306 was used to rank high risk calls, CS_SPDB may be set to a conservative value, such as [7,8,9,10] but wider than CS_FPDB. In one implementation, CS_SPDB may include deciles in the range of [1, 10] and the default value=[7, 8, 9, 10].

CS_SPDC may designate, in absolute terms, particular deciles for callers nearing breach for pairing when model C 308 generated the ranking. The higher the number of deciles starting from 10, the higher the chances of more callers being considered for pairing. Setting this number high may compromise the optimization goals. If model C 308 was used to rank low risk calls, CS_SPDC may be set to cover additional deciles. In one implementation, CS_SPDC may specify deciles in the range [1, 10] and may include the default value of [5,6,7,8,9,10].

Data 328 may further include a request, with specific arguments, parameters, and data, to re-pairing model X1 312. Example data 328 may include: CS_FPDB=[9,10]; CS_FPDC=[8,9,10]; CS_TTSLAB=45 secs; CS_SPDB=[7,8,9,10]; CS_SPDC=[6,7,8,9,10]; AS_TTSLAB=45 secs; AS_TNDANSB=[5,67,8,9,10]; AS_BEDS=0; and AS_CEDS=2. In response, re-pairing model X1 312 may re-rank the agents and/or callers, for pairing with particular callers. In addition, data 328 may include an inputs for requesting re-pairing model X1 312 to re-rank agents and/or callers.

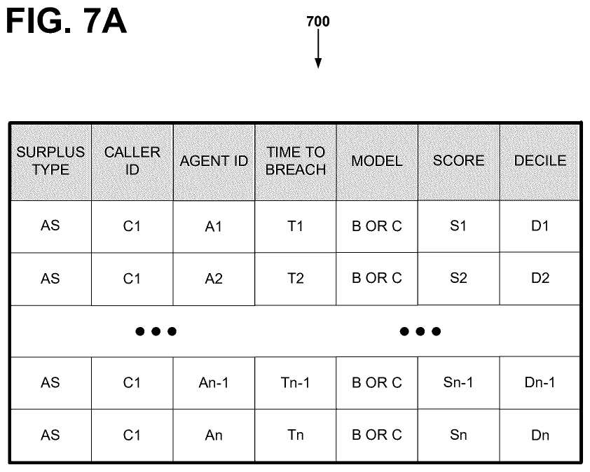

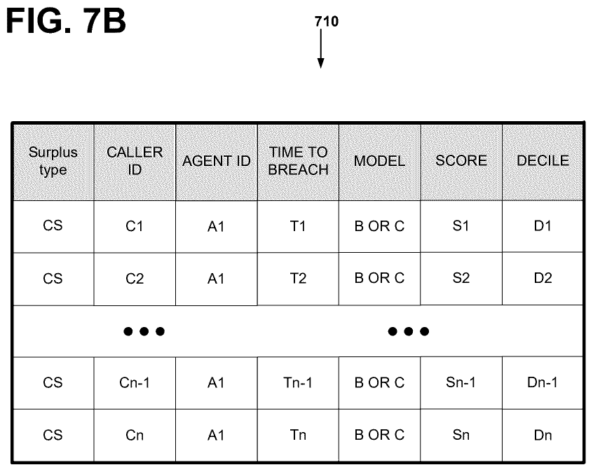

FIGS. 7A and 7B show tables 700 and 710 summarizing example inputs to a re-pairing model X1 312, according to the second implementation. Table 700 is similar to table 400 for the first implementation of re-pairing system 301, except that table 700 includes an extra column for SURPLUS TYPE. Table 710 shown in FIG. 7B is similar to table 700, except that fields in column SURPLUS TYPE indicates CS (“caller surplus”) rather than AS. In addition, in table 710, the fields in column CALLER ID show varying caller IDs (e.g., C1, C2 . . . ) whereas in the corresponding fields in table 700 show a single caller ID of C1; and in table 710, the fields in column AGENT ID show a single agent ID (A1), whereas in the corresponding fields in table 710 show varying agent IDs (e.g., A1, A2 . . . ).

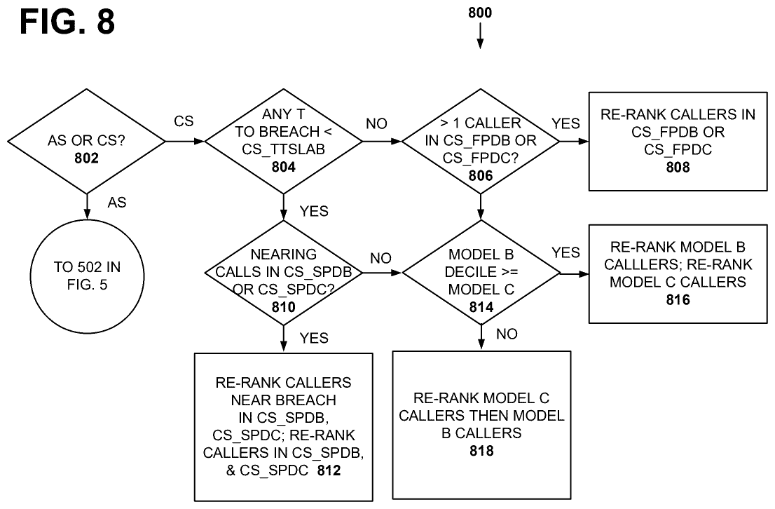

FIG. 8 is a flow diagram of an example process 800 that is associated with the second implementation of re-pairing model X1 312. As shown, process 312 may include re-pairing model X1 312 determining whether the request for re-pairing is for CS or AS (block 802). If it is for AS (block 802: AS), process 800 may proceed to block 502 of process 500 in FIG. 5. Otherwise (block 802: CS), re-pairing model X1 312 may determine if there are any callers with time-to-breach<CS_TTSLAB (block 804).

If there are any callers whose time-to-breach<CS_TTSLAB (block 804: YES), re-pairing model X1 312, may determine if there are callers whose time-to-breach is near CS_TTSLAB and belong to CS_FPDB or CS_FPDC (block 810). If so (block 810: YES), re-pairing model X1 312 may: re-rank callers whose time-to-breach is near breach and are in CS_SPDB in the order of increasing time-to-breach; re-rank callers whose time-to-breach is near breach and are in CS_SPDC in the order of increasing time-to-breach; re-rank callers in CS_SPDB in the order of increasing time to breach; re-rank callers in CS_SPDC in the order of increasing time to breach; and maintain the rankings for the remainder of the callers.

At block 810. If there is no caller whose time-to-breach is nearing CS_TTSLAB and belongs to CS_FPDB or CS_FPDC (block 810: NO), re-pairing model X1 312 may determine whether model B 306 deciles>=model C 308 deciles (block 814). If yes (block 814: YES), re-pairing model X1 312 may re-rank callers ranked in model B 306 in the order of decreasing scores; and re-rank callers ranked in model C 308 in the order of decreasing scores (block 816).

At block 814, if model B 306 deciles are not>=model C 308 deciles (block 814: NO), re-pairing model X1 312 may rank callers ranked in model C 308 in the order of decreasing scores; and rank callers ranked in model B 306 in the order of decreasing scores (block 818).

Returning to block 804, if there are no callers whose time-to-breach<CS_TTSLAB (block 804: NO), re-pairing model X1 312 may determine if there is more than one caller in CS_FPDB or CS_FPDC (block 806). If there are (block 806: YES), re-pairing model X1 312 may re-rank agents in CS_FPDB in the order of increasing time-to-breach; rank agents in CS_FPDC in the order of increasing time-to-breach; and maintain the rankings for the remainder of callers (block 808). If there is no caller in CS_FPDB or CS_FPDC (block 806: NO), re-pairing model X1 312 may proceed to block 814.

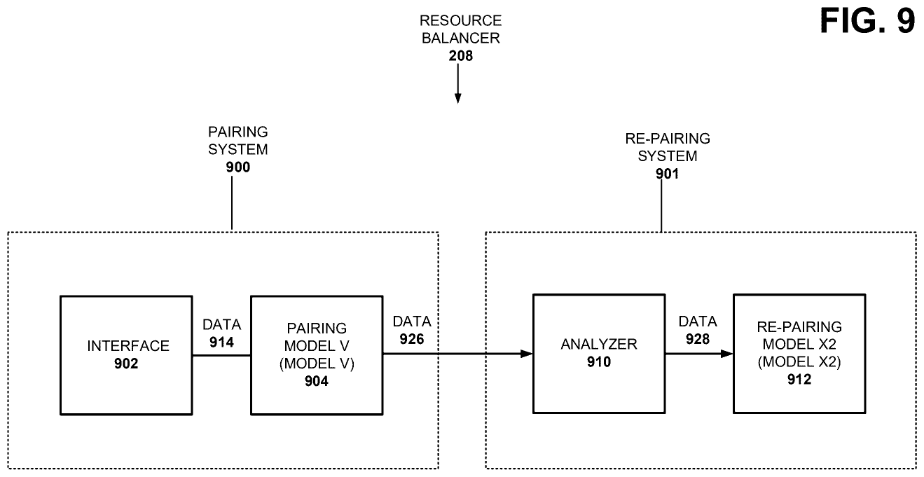

FIG. 9 illustrate exemplary components of resource balancer 208, according to a second implementation. As shown, resource balancer 208 may include a pairing system 900 and a re-pairing system 901. Pairing system 900 and re-pairing system 901 may operate similarly to pairing system 300 and re-pairing system 301 of FIG. 3. That is, pairing system 900 may generate a ranked list of agents/callers. Re-pairing system 901 may re-rank the ranked list of agents/callers generated by pairing system 900, to remove biases that pairing system 900 may have injected into its rankings.

As further shown, pairing system 300 may include input interface 902 and a pairing model V (model V) 904. Interface 902 may receive caller IDs for calls to be routed, IDs of agents 110 (in call center 106) who may receive the calls, and other information (e.g., agent availability, their performance, etc.) and provide the information needed by model V 904 to rank the agents/callers. Model V 904 may generate a list of ranked agents/callers based on data 914 received from interface 902, in the manner of model B 306 or model C 308 in FIG. 3.

Re-pairing system 901 may include a third implementation and a fourth implementation. In both the third and fourth implementations, re-pairing system 901 may include an analyzer 910 and a re-pairing model X2 912. In the third implementation, analyzer 910 and re-pairing model X2 912 may be configured to operate in a manner similar to the second implementation of re-pairing system 301 but with the TTSLAB_N replacing TTSLAB (e.g., CS_TTSLAB or AS_TTSLAB), where TTSLAB_N may be determined by Mean Idle Time +N x standard deviation of the idle times. TND_N may indicate a number of deciles from the best (highest) decile. Accordingly, TND_0>TND_1>TND_2>TND_3, etc.

In the fourth implementation, analyzer 910 and re-pairing model X2 912 may be configured to operate similarly as the third implementation but may also be capable of handling messaging (e.g., live chats with callers). A chat agent may hold more than one conversation (session) at a time, unlike a voice or video agent that can only hold one conversation at a time. Thus, in the fourth implementation, an agent can have 0, 1, 2, etc., simultaneous chats. TTSLAB (how soon until an agent may breach SLA thresholds) and decile (score bins) may be used to dynamically determine which deciles are equivalent.

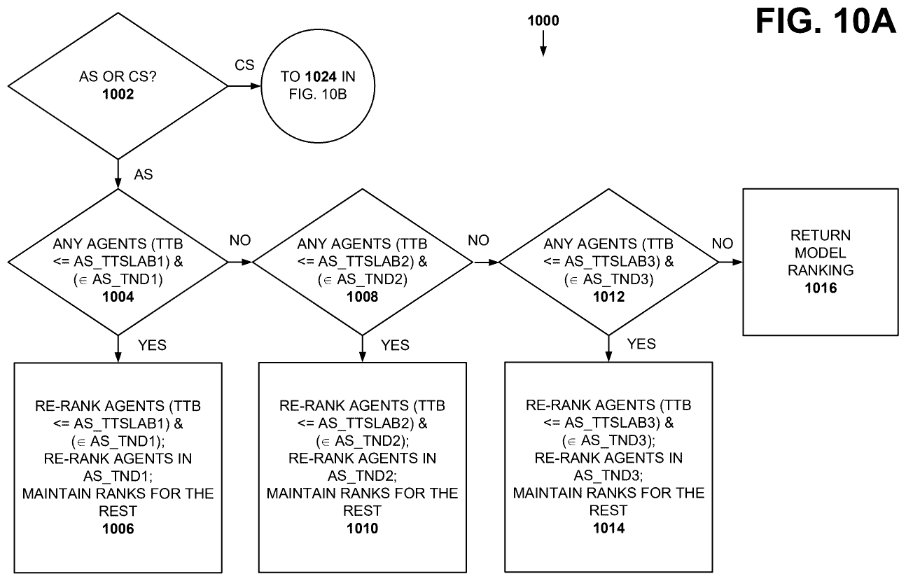

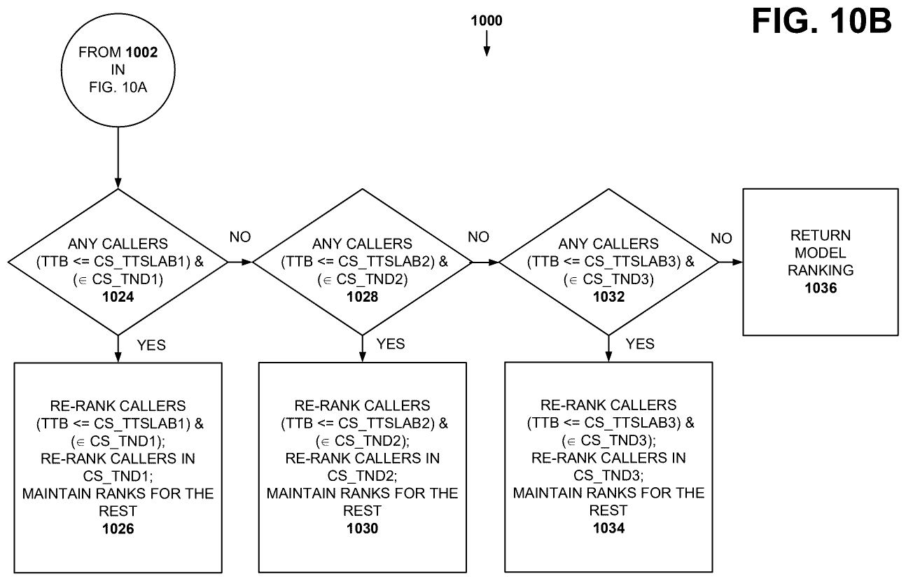

FIGS. 10A and 10B are flow diagrams of an example process 1000 that is associated with a re-pairing model, according to a third implementation. As shown, process 1000 may include determining whether the re-ranking is to be performed for CS or AS (block 1002). If the re-ranking is to be performed for CS (block 1002: CS), process 1000 may proceed to block 1024 in FIG. 10B. Otherwise, process 1000 may proceed to block 1004.

At block 1004, re-pairing model X2 912 may determine if there are any agents with (TTB<=AS_TTSLAB_1) and (ϵ AS_TND_1) (block 1004). Symbol “ϵ” indicates “is a member of.” If there are (block 1004: YES), re-pairing model X2 912 may re-rank agents with (TTB<=AS_TTBSLAB_1) and (ϵ AS_TND_1) in the order of increasing time-to-breach; re-rank agents in AS_TND_1 in the order of increasing time-to-breach; and maintain the rankings for the remaining agents (block 1006). Otherwise (block 1004: NO), process 1000 may proceed to block 1008.

At block 1008, re-pairing model X2 912 may determine if there are any agents with (TTB<=AS_TTSLAB_2) and (ϵ AS_TND_2) (block 1008). If there are (block 1008: YES), re-pairing model X2 912 may re-rank agents with (TTB<=AS_TTBSLAB_2) and (ϵ AS_TND_2) in the order of increasing time-to-breach; re-rank agents in AS_TND_2 in the order of increasing time-to-breach; and maintain the rankings for the remaining agents (block 1010). Otherwise (block 1008: NO), process 1000 may proceed to block 1012.

At block 1012, re-pairing model X2 912 may determine if there are any agents with (TTB<=AS_TTSLAB_3) and (ϵ AS_TND_3) (block 1012). If there are (block 1012: YES), re-pairing model X2 912 may re-rank agents with (TTB<=AS_TTBSLAB_3) and (ϵ AS_TND_3) in the order of increasing time-to-breach; re-rank agents in AS_TND_3 in the order of increasing time-to-breach; and maintain the rankings for the remaining agents (block 1014). Otherwise (block 1012: NO), process 1000 may proceed to block 1016, where re-pairing model X2 912 may return the ranking provided by model V 904.

At block 1024 (FIG. 10B), re-pairing model X2 912 may determine if there are any callers with (TTB<=CS_TTSLAB_1) and (ϵ CS_TND_1) (block 1024). If there are (block 1024: YES), re-pairing model X2 912 may re-rank callers with (TTB<=CS_TTBSLAB_1) and (ϵ CS_TND_1) in the order of increasing time-to-breach; re-rank callers in CS_TND_1 in the order of increasing time-to-breach; and maintain the rankings for the remaining callers (block 1026). Otherwise (block 1024: NO), process 1000 may proceed to block 1028.

At block 1028, re-pairing model X2 912 may determine if there are any callers with (TTB<=CS_TTSLAB_2) and (ϵ CS_TND_2) (block 1028). If there are (block 1028: YES), re-pairing model X2 912 may re-rank callers with (TTB<=CS_TTBSLAB_2) and (ϵ CS_TND_2) in the order of increasing time-to-breach; re-rank callers in CS_TND_2 in the order of increasing time-to-breach; and maintain the rankings for the remaining callers (block 1030). Otherwise (block 1028: NO), process 1000 may proceed to block 1032.

At block 1032, re-pairing model X2 912 may determine if there are any callers with (TTB<=CS_TTSLAB_3) and (ϵ CS_TND_3) (block 1032). If there are (block 1032: YES), re-pairing model X2 912 may re-rank callers with (TTB<=CS_TTBSLAB_3) and (ϵ CS_TND_3 in the order of increasing time-to-breach; re-rank callers in CS_TND_3 in the order of increasing time-to-breach; and maintain the rankings for the remaining callers (block 1034). Otherwise (block 1032: NO), process 1000 may proceed to block 1036, where re-pairing model X2 912 may return the ranking provided by model V 904.

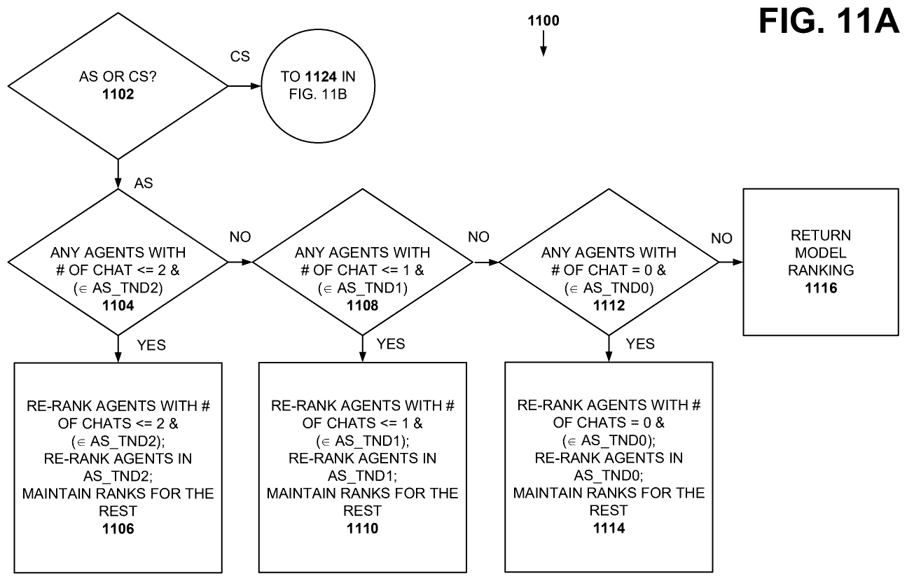

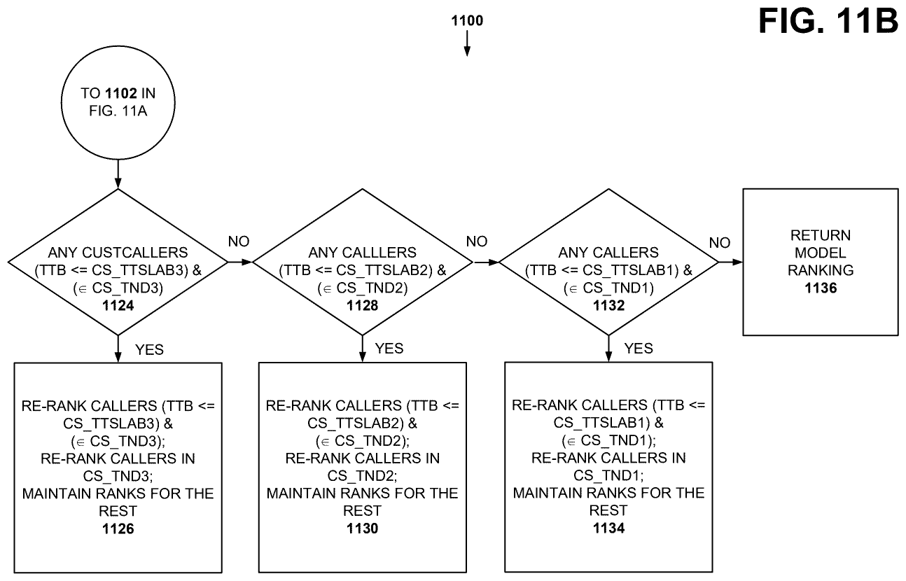

FIGS. 11A and 11B are flow diagrams of an example process 1100 that is associated with a re-pairing model, according to a fourth implementation. As shown, process 1100 may include determining whether the re-ranking is to be performed for CS or AS (block 1102). If the re-ranking is to be performed for CS (block 1102: CS), process 1100 may proceed to block 1124 in FIG. 11B. Otherwise, process 1100 may proceed to block 1104).

At block 1104, re-pairing model X2 912 may determine if there are any agents with # of chats<=2) and (ϵ AS_TND_2) (block 1104). If there are (block 1104: YES), re-pairing model X2 912 may re-rank agents with (# of chats<=2) and (ϵ AS_TND_2) in the order of increasing time-to-breach; re-rank agents in AS_TND_2 in the order of increasing time-to-breach; and maintain the rankings for the remaining agents (block 1106). Otherwise (block 1104: NO), process 1100 may proceed to block 1108.

At block 1108, re-pairing model X2 912 may determine if there are any agents with # of chats<=1) and (ϵ AS_TND_1) (block 1108). If there are (block 1108: YES), re-pairing model X2 912 may re-rank agents with (# of chats<=1) and (ϵ AS_TND_1) in the order of increasing time-to-breach; re-rank agents in AS_TND_1 in the order of increasing time-to-breach; and maintain the rankings for the remaining agents (block 1110). Otherwise (block 1108: NO), process 1100 may proceed to block 1112.

At block 1112, re-pairing model X2 912 may determine if there are any agents with # of chats=0) and (ϵ AS_TND_0) (block 1112). If there are (block 1112: YES), re-pairing model X2 912 may re-rank agents with (# of chats=0) and (ϵ AS_TND_0) in the order of increasing time-to-breach; re-rank agents in AS_TND_0 in the order of increasing time-to-breach; and maintain the rankings for the remaining agents (block 1114). Otherwise (block 1112: NO), re-pairing model X2 912 may return the ranking from model V 904 (block 1116).

At block 1124 (FIG. 11B), re-pairing model X2 912 may determine if there are any callers with (TTB<=CS_TTSLAB_3) and (ϵ CS_TND_3) (block 1124). If there are (block 1124: YES), re-pairing model X2 912 may re-rank callers with (TTB<=CS_TTBSLAB_3) and (ϵ CS_TND_3) in the order of increasing time-to-breach; re-rank callers in CS_TND_3 in the order of increasing time-to-breach; and maintain the rankings for the remaining callers (block 1126). Otherwise (block 1124: NO), process 1100 may proceed to block 1128.

At block 1128, re-pairing model X2 912 may determine if there are any callers with (TTB<=CS_TTSLAB_2) and (ϵ CS_TND_2) (block 1128). If there are (block 1128: YES), re-pairing model X2 912 may re-rank callers with (TTB<=CS_TTBSLAB_2) and (ϵ CS_TND_2) in the order of increasing time-to-breach; re-rank callers in CS_TND_2 in the order of increasing time-to-breach; and maintain the rankings for the remaining callers (block 1130). Otherwise (block 1128: NO), process 1100 may proceed to block 1132.

At block 1132, re-pairing model X2 912 may determine if there are any callers with (TTB<=CS_TTSLAB_1) and (ϵ CS_TND_1) (block 1132). If there are (block 1132: YES), re-pairing model X2 912 may re-rank callers with (TTB<=CS_TTBSLAB_1) and (ϵ CS_TND_1) in the order of increasing time-to-breach; re-rank callers in CS_TND_1 in the order of increasing time-to-breach; and maintain the rankings for the remaining callers (block 1134). Otherwise (block 1132: NO), re-pairing model X2 912 may return the ranking from model V 904.

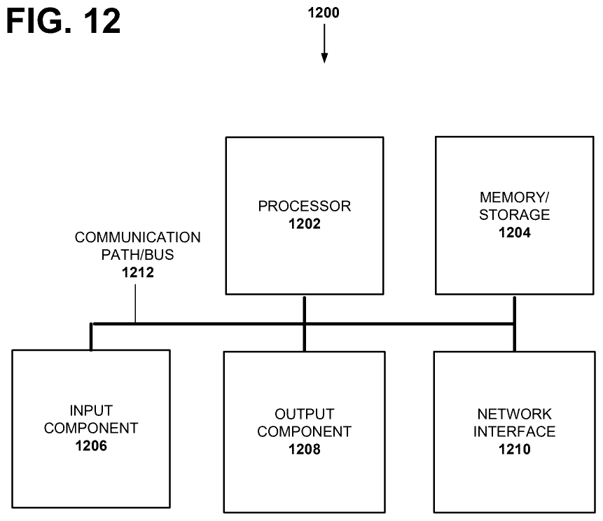

FIG. 12 depicts exemplary components of a network device 1200. Network device 1200 may correspond to or be included in any of the devices and/or components illustrated in FIGS. 1-3 and 9 (e.g., UE 102, network 104, call center 106, RPMS 108, agents 110, components 202-210, components 302-312, components 902-904 and 910-912, etc., or other devices not shown in the figures). In some implementations, network devices 1200 may be part of a hardware network layer on top of which other network layers and network functions may be implemented.

As shown, network device 1200 may include a processor 1202, memory/storage 1204, input component 1206, output component 1208, network interface 1210, and communication path 1212. In different implementations, network device 1200 may include additional, fewer, different, or different arrangement of components than the ones illustrated in FIG. 12. For example, network device 1200 may include line cards, switch fabrics, modems, etc.

Processor 1202 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1200 and/or executing programs/instructions.

Memory/storage 1204 may include static memory, such as read only memory (ROM), and/or dynamic memory, such as random access memory (RAM), or onboard cache, for storing data and machine-readable instructions (e.g., programs, scripts, etc.). Memory/storage 1204 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1204 may be external to and/or removable from network device 1200.

Memory/storage 1204 may include, for example, a Universal Serial Bus (USB) memory stick, a dongle, a hard disk, off-line storage, a Blu-Ray® disk (BD), etc. Memory/storage 1204 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1206 and output component 1208 may provide input and output from/to a user to/from network device 1200. Input/output components 1206 and 1208 may include a display screen, a keyboard, a mouse, a speaker, a microphone, a camera, a DVD reader, USB lines, and/or other types of components for obtaining, from physical events or phenomena, to and/or from signals that pertain to network device 1200.

Network interface 1210 may include a transceiver (e.g., a transmitter and a receiver) for network device 1210 to communicate with other devices and/or systems. For example, via network interface 1210, network device 1200 may communicate over a network, such as the Internet, an intranet, cellular, a terrestrial wireless network (e.g., a wireless LAN, WIFI, WIMAX, etc.), a satellite-based network, optical network, etc. Network interface 1210 may include a modem, an Ethernet interface to a LAN, and/or an interface/connection for connecting network device 1200 to other devices (e.g., a Bluetooth interface).

Communication path or bus 1212 may provide an interface through which components of network device 1200 can communicate with one another.

Network device 1200 may perform the operations described herein in response to processor 1202 executing software instructions stored in a non-transient computer-readable medium, such as memory/storage 1204. The software instructions may be read into memory/storage 1204 from another computer-readable medium or from another device via network interface 1210. The software instructions stored in memory/storage 1204, when executed by processor 1202, may cause processor 1202 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions have been described with reference to FIGS. 5, 8, 10A, 10B, 11A, and 11B. the order of the actions may be modified in other implementations. In addition, non-dependent actions may represent actions that can be performed in parallel and in different orders. Furthermore, each of actions illustrated may include one or more other actions.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code - it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising a processor configured to:
receive a request to re-rank a list of ranked agents or callers; and
in response to determining that there are more agents than callers:
generate a list of re-ranked agents based on the list of ranked agents; and
provide the list of re-ranked agents to a system for routing calls to one of agents identified in the list of re-ranked agents.

2. The device of claim 1, when generating the list of re-ranked agents, the processor is configured to:
identify agents that are close to breaching a service-level agreement (SLA); and
re-rank the identified agents in the order of increasing time-to-breach for each of the identified agents.

3. The device of claim 2, wherein when identifying the agents that are close to breaching the SLA, the processor is configured to:
identify a first set of agents whose time-to-breach is less than a threshold value; or
from the first set of agents, select a subset of agents that belong to a group of agents closest to breaching the SLA.

4. The device of claim 3, wherein when re-ranking the identified agents, the processor is further configured to at least one of:
re-rank the subset of agents in the order of increasing time-to-breach for each of the agents in the subset of agents; or
re-rank the first set of agents in the order of increasing time-to-breach for each of the agents in the first set of agents.

5. The device of claim 2,
in response to determining that no agent is identified as close to breaching the SLA:
identify a set of equivalent agents that contribute a same amount of cost or revenue in connection with handling the calls; and
re-rank the set of equivalent agents in the order of increasing time-to-breach.

6. The device of claim 2, wherein the processor is further configured to:
in response to determining that no agent is identified as close to breaching the SLA, provide the list of ranked agents without changing the order of the agents in the list.

7. The device of claim 1, wherein in response to determining that there are more callers than agents, the processor is configured to:
re-rank the list of callers; and
provide the re-ranked list of callers to the system.

8. The device of claim 7, wherein when re-ranking the list of callers, the processor is configured to:
identify a set of callers that are close to breaching a service-level agreement (SLA).

9. The device of claim 1, wherein the ranked list of agents is generated by an artificial intelligence (AI) model.

10. The device of claim 1, wherein the calls include chats, and wherein when generating the list of re-ranked agents, the processor is configured to:
generate the list of re-ranked agents based on a number of chats being conducted by each of the agents.

11. A method comprising:
receiving a request to re-rank a list of ranked agents or callers;
in response to determining that there are more agents than callers:
generating a list of re-ranked agents based on the list of ranked agents; and
providing the list of re-ranked agents to a system for routing calls to agents identified in the list of re-ranked agents.

12. The method of claim 11, wherein generating the list of re-ranked agents comprises:
identifying agents that are close to breaching a service-level agreement (SLA); and
re-ranking the identified agents in the order of increasing time-to-breach for each of the identified agents.

13. The method of claim 12, wherein identifying the agents that are close to breaching the SLA comprises:
deriving a first set of agents whose time-to-breach is less than a threshold value; or
from the first set of agents, selecting a subset of agents that belong to a group of agents closest to breaching the SLA.

14. The method of claim 13, wherein re-ranking the identified agents further comprises:
re-ranking the subset of agents in the order of increasing time-to-breach for each of the agents in the subset; or
re-ranking the first set of agents in the order of increasing time-to-breach for each of the agents in the first set.

15. The method of claim 12, further comprising:
in response to determining that no agent is identified as close to breaching an SLA:
identifying a set of equivalent agents that contribute a same amount of cost or revenue in connection with handling calls; and
re-ranking the set of equivalent agents in the order of increasing time-to-breach.

16. The device of claim 12, further comprising:
in response to determining that no agent is identified as close to breaching an SLA, providing the list of ranked agents without changing the order of the agents in the list.

17. The method claim 11, when there are more callers than agents, further comprising:
re-ranking the list of callers; and
providing the list of re-ranked callers to the system.

18. The method of claim 17, wherein re-ranking the list of callers comprises:
identifying a set of callers that are close to breaching a service-level agreement (SLA).

19. The method claim 11, wherein the list of ranked agents is generated by an artificial intelligence (AI) model.

20. A non-transitory computer-readable medium comprising processor executable instructions, which when executed by a processor, cause the processor to:
receive a request to re-rank a list of ranked agents or callers;
in response to determining that there are more agents than callers,
generate a list of re-ranked agents based on the list of ranked agents; and
provide the list of re-ranked agents to a system for routing calls to one of agents identified in the list of re-ranked agents.
